(19) United States
(12) Patent Application Publication
(10) Pub. No.: US 2025/0172426 A1
(43) Pub. Date: May 29, 2025

(54) SYSTEMS AND METHODS FOR AUTOMATICALLY WEIGHING A SUBSTANCE AND FILLING A CONTAINER WITH THE SUBSTANCE

(71) Applicant: Coastal Counting & Industrial Scale Company, Inc., Santa Paula, CA (US)

(72) Inventors: Jason Satnick, Ventura, CA (US); John Dishion, Oxnard, CA (US); Roberto Santos, Oxnard, CA (US); Hasala Senevirathne, Los Angeles, CA (US)

(73) Assignee: Coastal Counting & Industrial Scale Company, Inc., Santa Paula, CA (US)

(21) Appl. No.: 18/963,141

(22) Filed: Nov. 27, 2024

Related U.S. Application Data
(60) Provisional application No. 63/603,101, filed on Nov. 27, 2023.

(51) Int. Cl. G01G 13/16; B65B 1/06; B65B 1/32; B65B 29/00; B65B 37/02; B65B 37/10

(52) U.S. Cl. CPC G01G 13/16; B65B 1/06; B65B 1/32; B65B 29/00; B65B 37/02; B65B 37/10

(57) ABSTRACT

A filling system includes a first hopper for receiving a smokable product, a second hopper for receiving the smokable product, a feeder for receiving the smokable product from the first hopper, a bowl feeder for receiving the smokable product from the second hopper, a weigh bucket for receiving the smokable product from the feeder and the bowl feeder, a load cell attached to the weigh bucket for measuring the smokable product in the weigh bucket, and a funnel for receiving the smokable product from the weigh bucket and feeding the smokable product to a container. The container is configured to receive a predetermined amount of smokable product within a predetermined tolerance of the predetermined amount.

### CROSS-REFERENCE TO RELATED APPLICATIONS

This patent application claims priority of U.S. Provisional Patent Application No. 63/603,101, entitled “SYSTEMS AND METHODS FOR AUTOMATICALLY WEIGHING A SUBSTANCE AND FILLING A CONTAINER WITH THE SUBSTANCE,” filed Nov. 27, 2023, which is hereby incorporated by reference in its entirety.

### TECHNICAL FIELD

The present invention is in the technical field of weighing and filling systems and more particularly to an accurate net weight-based filling system for filling a container in a compliant, consistent, repeatable, and scalable manner.

### BACKGROUND

Currently available systems for weighing products and filling containers do not fill the container with an accurately measured amount of the substance. For example, in the smokable products industry, containers of smokable products may be hand filled. The person manually filling the product measures an amount of the smokable product on a weighing device and manually fills the container with the weighed smokable product. The weighing device may be of low quality and may not be accurate, and smokable product may be lost in the transfer from the weighing device into the preroll. As such, an unknown amount of the smokable product may be filled in the container.

Additionally, federal, state, and local regulations may require that the amount of smokable substance within the container be within a predetermined tolerance. Specifically, at least some regulations require that a container of smokable product have an actual weight that is within the predetermined tolerance of a predetermined weight. More specifically, at least some regulations require that the actual weight of the container of smokable product be within ±3% of the predetermined weight. For example, some regulations require that the actual weight of the container of smokable product be within ±3% of 0.5 grams (g). Manually weighing and filling of containers of smokable product may result in loses of up to 20% of the smokable product because the filler may not accurately weigh the product, resulting in the container of smokable product being discarded because it does not meet regulatory requirements.

Currently available systems for automatically filling and weighing the container of smokable products use a volume method that is unreliable and not useful for many critical applications. Specifically, the volume method may does not accurately weigh the product such that the actual weight of the container of smokable products is within the predetermined tolerance of the predetermined weight. Further, the volume method, and other weighing methods, have difficultly accurately weighing smokable products with speed and accuracy.

Therefore, there is a need for a weighing and filling system that overcomes the above referenced limitations by providing an accurate net weight based filling system for filling a container in a compliant, consistent, repeatable, and scalable manner.

### SUMMARY

The disclosed technology includes apparatus and methods for weighing and filling a container with a substance in a compliant, consistent, repeatable, and scalable method. By way of example, the apparatus and methods may be used for weigh and fill cannabis in both flower form and ground shake form. However, any other smoking product, food product, or other product may be used with the disclosed apparatus and methods.

An aspect of the present disclosure relates to a filling system including a first hopper for receiving a smokable product, a second hopper for receiving the smokable product, a feeder for receiving the smokable product from the first hopper, a bowl feeder for receiving the smokable product from the second hopper, a weigh bucket for receiving the smokable product from the feeder and the bowl feeder, a load cell attached to the weigh bucket for measuring the smokable product in the weigh bucket, and a funnel for receiving the smokable product from the weigh bucket. In some embodiments, there may be a manual funnel output. In some embodiments, funnel may feed the smokable product to a container. For example, the system may be integrated with fully automated pouch or jar lines. The container is configured to receive a predetermined amount of smokable product within a predetermined tolerance of the predetermined amount.

An aspect of the present disclosure relates to a filling system that has the capability to weight 20-24 cpm at an accuracy of +/−3% with a high precision weigh module to accurately dose the smokable product.

Another aspect of the present disclosure relates to a filling system including a first hopper for receiving a smokable product, a second hopper for receiving the smokable product, a feeder for receiving the smokable product from the first hopper, a bowl feeder for receiving the smokable product from the second hopper and including a bowl, a sweep, and a channel, a weigh bucket for receiving the smokable product from the feeder and the bowl feeder, a load cell attached to the weigh bucket for measuring the smokable product in the weigh bucket, and a funnel for receiving the smokable product from the weigh bucket and feeding the smokable product to a container. The sweep is positioned within the bowl and configured to rotate within the bowl. The weigh bucket includes a receiving cylinder and a door. The receiving cylinder is configured to receive the smokable product from the feeder and from the channel. The door is configured to open to drop the smokable product into the funnel. The container is configured to receive a predetermined amount of smokable product within a predetermined tolerance of the predetermined amount. In some embodiments, the feeder drops individual nugs of the smokable product one at a time into the weigh bucket.

Yet another aspect of the present disclosure relates to a method of filling a container with a smokable product using a filling system. The filling system includes a first hopper, a second hopper, a feeder, a bowl feeder, a weigh bucket, a load cell, and a funnel. The method includes receiving the smokable product into the first hopper and the second hopper. The method also includes transporting the smokable product from the first hopper to the feeder. The method further includes transporting the smokable product from the second hopper to the bowl feeder. The method also includes transporting the smokable product from the feeder to the weigh bucket. The method further includes transporting the smokable product from the bowl feeder to the weigh bucket. The method also includes measuring the smokable product in the weigh bucket using the load cell. The method further includes determining that the smokable product in the weigh bucket is within a predetermined tolerance of a predetermined amount of smokable product. The method also includes opening the weigh bucket. The method further includes dropping the smokable product into the funnel. The method also includes dropping the smokable product from the funnel into the container.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 illustrates a perspective view of an accurate net weight based filling system for filling a container in a compliant, consistent, repeatable, and scalable manner in accordance with aspects of the current disclosure.

FIG. 2 illustrates a front view of the system shown in FIG. 1 in accordance with aspects of the current disclosure.

FIG. 3 illustrates a side view of the system shown in FIG. 1 in accordance with aspects of the current disclosure.

FIG. 4 illustrates a top view of the system shown in FIG. 1 in accordance with aspects of the current disclosure.

FIG. 5 is a perspective view of the first hopper shown in FIG. 1 in accordance with aspects of the current disclosure.

FIG. 6 is a schematic front view of the first hopper shown in FIG. 1 in accordance with aspects of the current disclosure.

FIG. 7 is a schematic side view of the first hopper shown in FIG. 1 in accordance with aspects of the current disclosure.

FIG. 8 is a schematic top view of the first hopper shown in FIG. 1 in accordance with aspects of the current disclosure.

FIG. 9 is a perspective view of the second hopper shown in FIG. 1 in accordance with aspects of the current disclosure.

FIG. 10 is a schematic front view of the second hopper shown in FIG. 1 in accordance with aspects of the current disclosure.

FIG. 11 is a schematic side view of the second hopper shown in FIG. 1 in accordance with aspects of the current disclosure.

FIG. 12 is a schematic top view of the second hopper shown in FIG. 1 in accordance with aspects of the current disclosure.

FIG. 13 is a perspective view of the feeder shown in FIG. 1 in accordance with aspects of the current disclosure.

FIG. 14 is a schematic front view of the feeder shown in FIG. 1 in accordance with aspects of the current disclosure.

FIG. 15 is a schematic side view of the feeder shown in FIG. 1 in accordance with aspects of the current disclosure.

FIG. 16 is a schematic top view of the feeder shown in FIG. 1 in accordance with aspects of the current disclosure.

FIG. 17 is a perspective view of the bowl feeder shown in FIG. 1 in accordance with aspects of the current disclosure.

FIG. 18 is a schematic side view of the bowl feeder shown in FIG. 1 in accordance with aspects of the current disclosure.

FIG. 19 is a schematic front view of the bowl feeder shown in FIG. 1 in accordance with aspects of the current disclosure.

FIG. 20 is a schematic top view of the bowl feeder shown in FIG. 1 in accordance with aspects of the current disclosure.

FIG. 21 is a perspective view of the cylinder mount shown in FIG. 1 in accordance with aspects of the current disclosure.

FIG. 22 is a schematic side view of the cylinder mount shown in FIG. 1 in accordance with aspects of the current disclosure.

FIG. 23 is a schematic front view of the cylinder mount shown in FIG. 1 in accordance with aspects of the current disclosure.

FIG. 24 is a schematic top view of the cylinder mount shown in FIG. 1 in accordance with aspects of the current disclosure.

FIG. 25 is a perspective view of the weigh bucket shown in FIG. 1 in accordance with aspects of the current disclosure.

FIG. 26 is a schematic side view of the weigh bucket shown in FIG. 1 in accordance with aspects of the current disclosure.

FIG. 27 is a schematic front view of the weigh bucket shown in FIG. 1 in accordance with aspects of the current disclosure.

FIG. 28 is a schematic top view of the weigh bucket shown in FIG. 1 in accordance with aspects of the current disclosure.

FIG. 29 is a perspective view of the load cell shown in FIG. 1 in accordance with aspects of the current disclosure.

FIG. 30 is a schematic side view of the load cell shown in FIG. 1 in accordance with aspects of the current disclosure.

FIG. 31 is a schematic front view of the load cell shown in FIG. 1 in accordance with aspects of the current disclosure.

FIG. 32 is a schematic top view of the load cell shown in FIG. 1 in accordance with aspects of the current disclosure.

FIG. 33 is a perspective view of the funnel shown in FIG. 1 in accordance with aspects of the current disclosure.

FIG. 34 is a schematic side view of the funnel shown in FIG. 1 in accordance with aspects of the current disclosure.

FIG. 35 is a schematic front view of the funnel shown in FIG. 1 in accordance with aspects of the current disclosure.

FIG. 36 is a schematic top view of the funnel shown in FIG. 1 in accordance with aspects of the current disclosure.

FIG. 37 illustrates a flow diagram of a method of filling a container with a smokable product using a filling system in accordance with aspects of the current disclosure.

FIG. 38 is a flowchart of operations for an example method of filling preroll cones with a smokable product using a filling system in accordance with aspects of the current disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

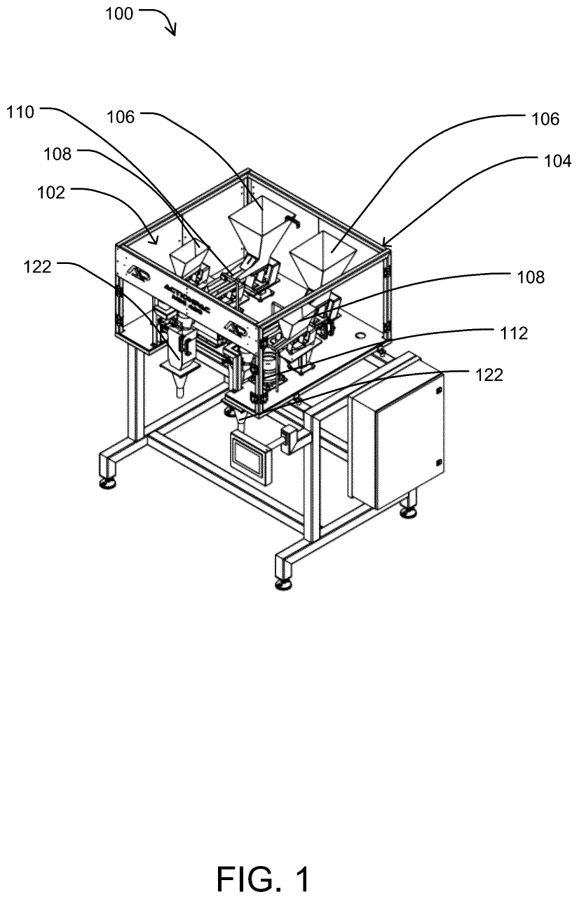

FIG. 1 illustrates a perspective view of an accurate net weight based filling system 100 for filling a container with a substance in a compliant, consistent, repeatable, and scalable method, according to one embodiment of the present invention. The accurate net weight based filling system 100 includes two identical trains 102 and 104. Each train 102 and 104 is configured to weigh a precise, predetermined amount of smokable product and fill a container with the smokable product. The system 100 includes two trains 102 and 104 to increase throughput and increase the reliability and availability of the system 100.

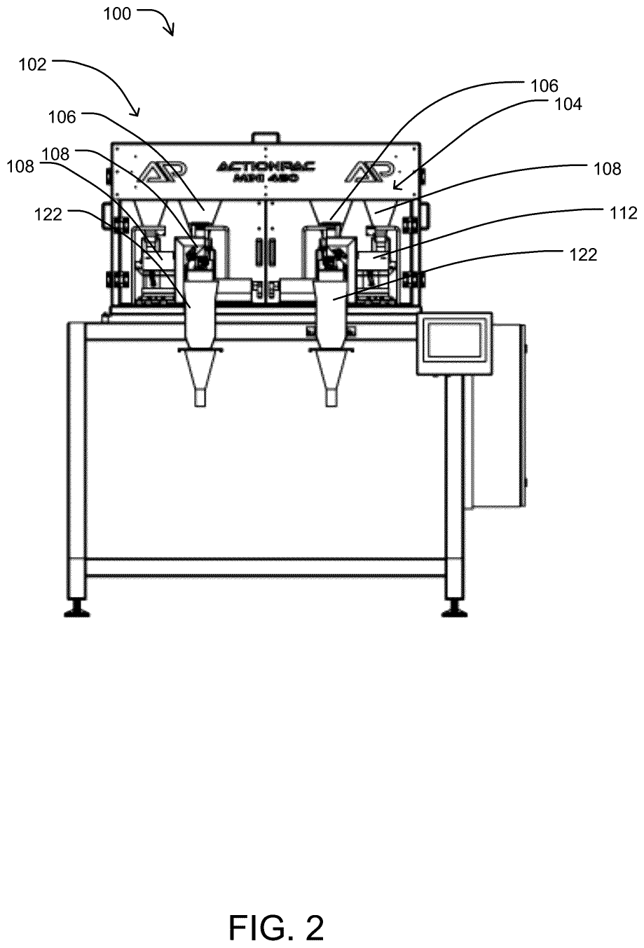

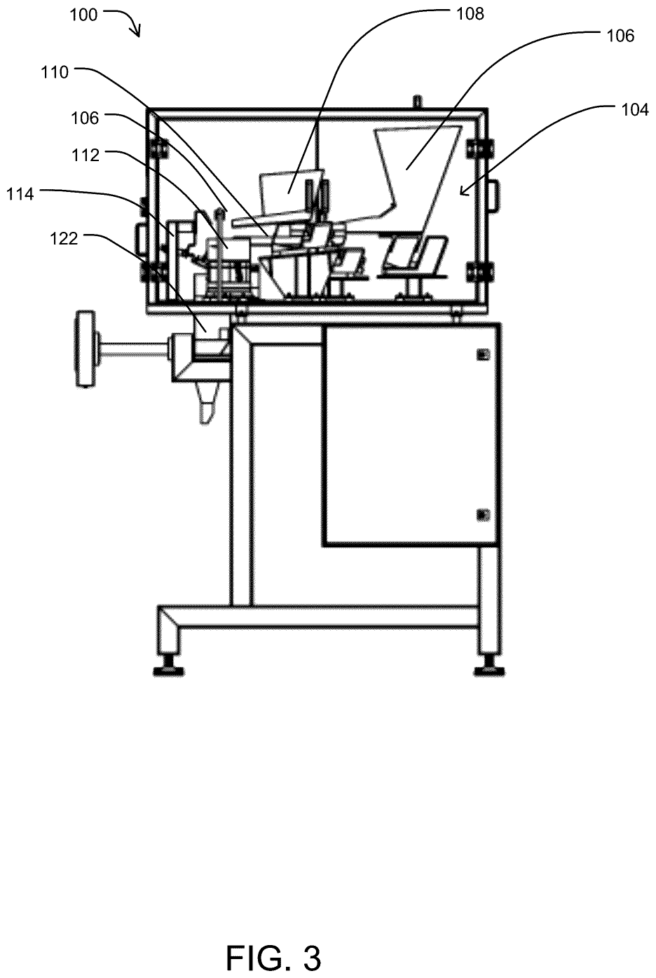

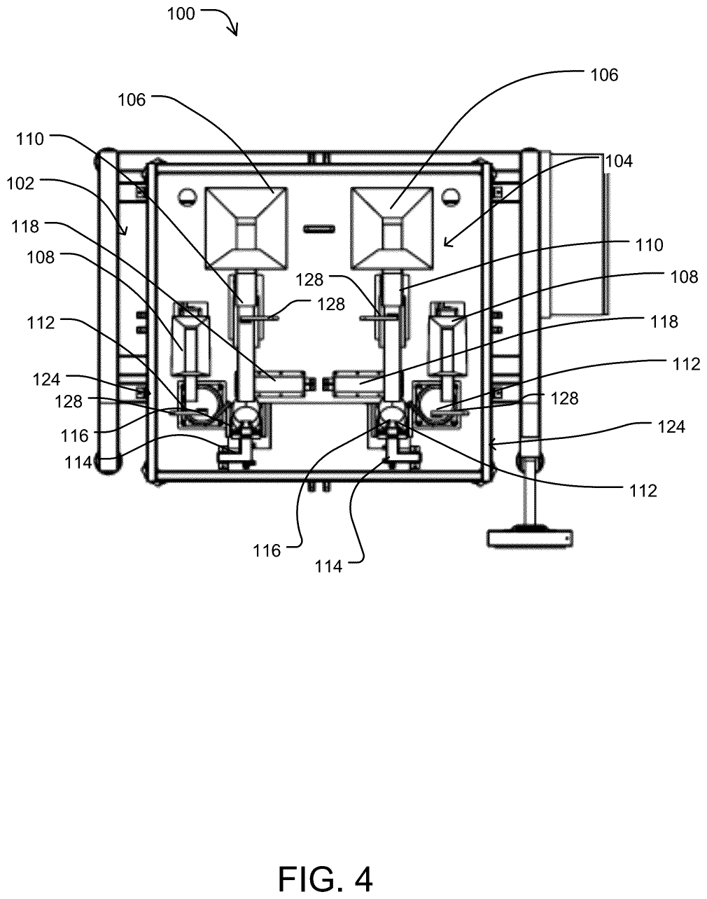

FIG. 2 illustrates a front view of the system 100 shown in FIG. 1. FIG. 3 illustrates a side view of the system 100 shown in FIG. 1. FIG. 4 illustrates a top view of the system 100 shown in FIG. 1. Each train 102 and 104 includes a first hopper 106, a second hopper 108, a feeder 110, a bowl feeder 112, a cylinder mount 114, a weight bucket 116, a load cell 118, and a funnel 122.

As shown in FIGS. 1-4, each train 102 and 104 of the system 100 includes the first hopper 106 and a second hopper 108. Both hoppers 102 and 104 are configured to contain a substance including, but not limited to, a smokable product. In the illustrated embodiment, the smokable product includes cannabis in any form. For example, the smokable product may be cannabis it is flower form and/or ground shake form. In alternative embodiments, the smokable product may include any product, including any smokable product, that enables the system 100 to operate as described herein. The first hopper 106, and the equipment downstream from the first hopper 106, is configured to provide a bulk amount of smokable product to a container and the second hopper 108, and the equipment downstream from the second hopper 108, is configured to provide small amount of smokable product to the container to ensure that the weight of the smokable product is within a predetermined tolerance of the predetermined amount of smokable product.

Each train 102 and 104 also includes the feeder 110 that is connected to the first hopper 106 such that the first hopper 106 feeds the smokable product to the feeder 110. The feeder 110 receives the smokable product from the first hopper 106 and feeds the smokable product to the rest of each train 102 and 104. Each train 102 and 104 further includes the bowl feeder 112 that is connected to the second hopper 108 such that the second hopper 108 feeds the smokable product to the bowl feeder 112. The bowl feeder 112 receives the smokable product from the second hopper 108 and feeds the smokable product to the rest of each train 102 and 104.

The cylinder mount 114, the weight bucket 116, the load cell 118, and the weigh bucket 116 define a measuring station 124. The measuring station 124 is configured to measure the weight of the smokable product received from the feeder 110 and the bowl feeder 112 and deliver the weighed smokable product to the funnel 122 and to the container. The weigh bucket 116 is attached to the load cell 118 such that the weigh bucket 116 is supported by the load cell 118 without any other support to ensure the accuracy of the measured weight. The weigh bucket 116 is actuated by a cylinder 126 attached to the cylinder mount 114 and configured to open the weigh bucket 116 without affecting the measured weight. The feeder 110 and the bowl feeder 112 are configured to deliver the smokable product to the weigh bucket 116 and the weigh bucket 116 is configured to weigh the smokable product and deliver the smokable product to the funnel 122 and the container.

That is, the weigh bucket 116 is connected to the feeder 110 and the bowl feeder 112 such that the feeder 110 and the bowl feeder 112 feed the smokable product to the weigh bucket 116. The load cell 118 is attached to the weigh bucket 116 for weighing the smokable product in the weigh bucket 116. The cylinder 126 is configured to open the weigh bucket 116 after the load cell 118 has weighed the smokable product in the weigh bucket such that the smokable product falls into the funnel 122 and the container. The flow of smokable product into the weigh bucket 116 is controlled by optical sensors 128 positioned above the feeder 110 and the bowl feeder 112. The optical sensors 128 detect smokable product in the feeder 110 and the bowl feeder 112 and turn on the feeder 110 and the bowl feeder 112 when little or no smokable product is detected and turn off the feeder 110 and the bowl feeder 112 when a predetermined amount of smokable product is detected in the feeder 110 and the bowl feeder 112.

During operation of the system 100, smokable product is loaded into the hoppers 106 and 108 and the hoppers 106 and 108 feed the smokable product into the feeder 110 and the bowl feeder 112. As discussed in greater detail below, the hoppers 106 and 108 and the feeder 110 and the bowl feeder 112 are designed to feed the smokable product to the measuring station 124 in a consistent manner. The feeder 110 and the bowl feeder 112 then feed the smokable product to the weigh bucket 116, and the load cell 118 then precisely weigh the smokable product in the weigh bucket 116 to ensure that each container is filled with the predetermined amount of smokable product. The optical sensors 128 control the flow of smokable product from the feeder 110 and the bowl feeder 112 to the weigh bucket 116. If the smokable product in the weigh bucket 116 is within a predetermined tolerance of the predetermined amount of smokable product, the weigh bucket 116 feeds the smokable product into the funnel 122 which feeds the smokable product into the container. Additionally, as described below, each portion of the measuring station 124 has been precisely designed to feed a consistent amount of smokable product through the measuring station 124 such that each container contains the predetermined amount of smokable product within the predetermined tolerance.

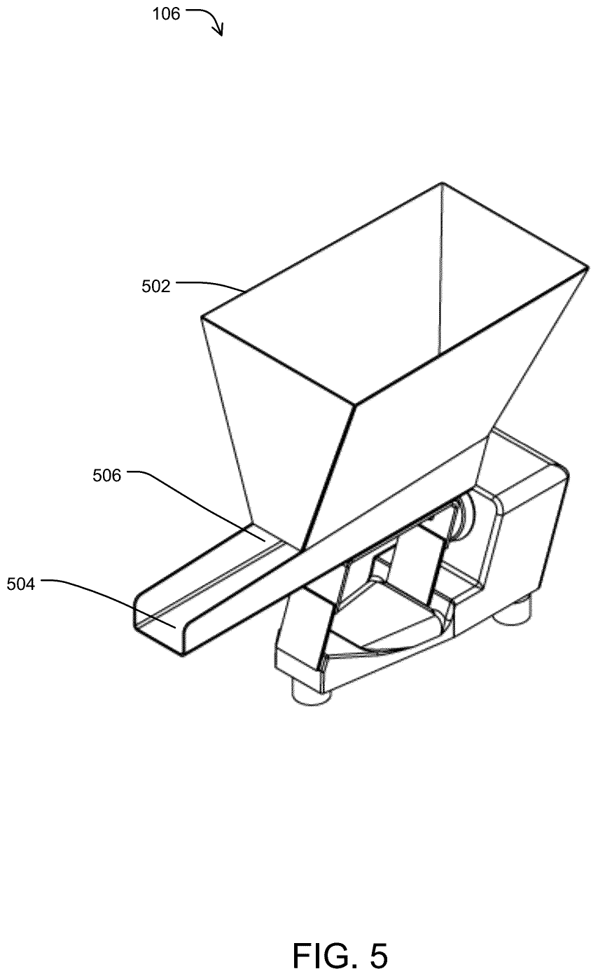

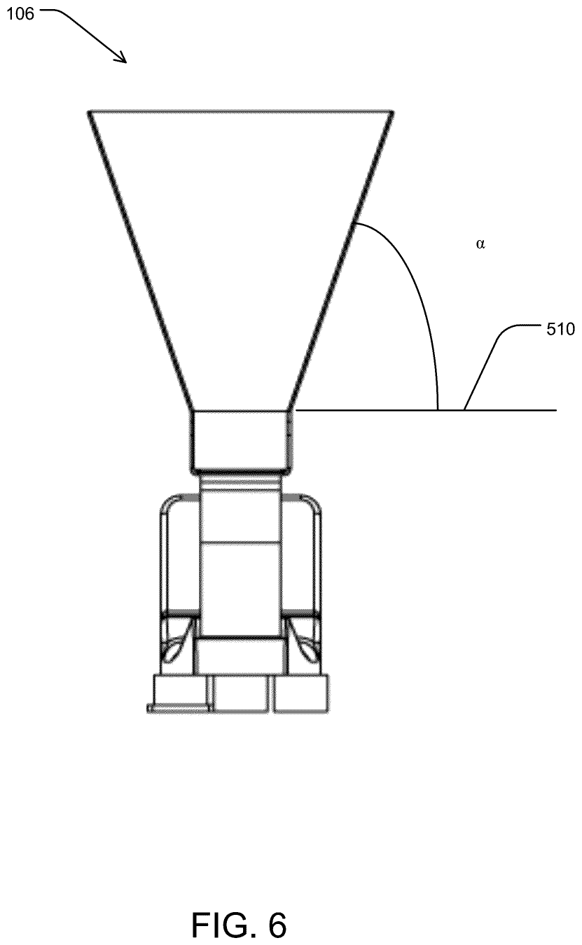

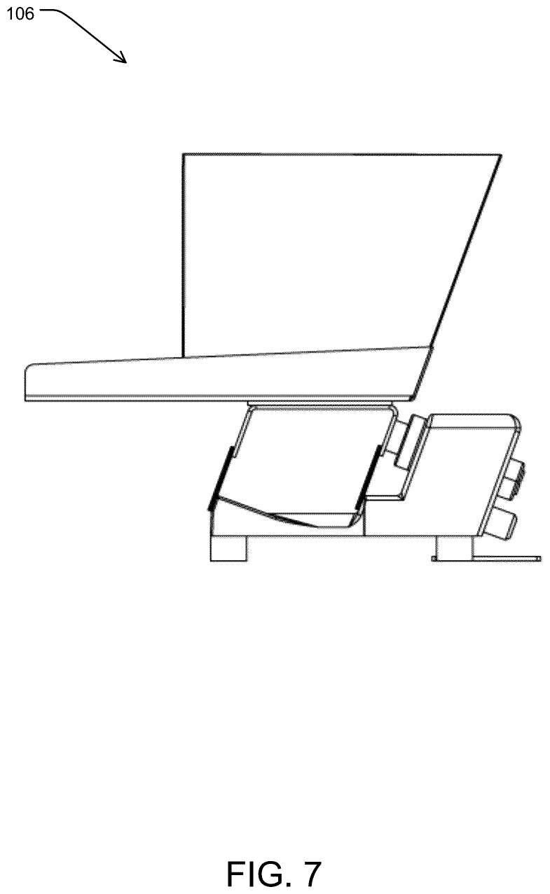

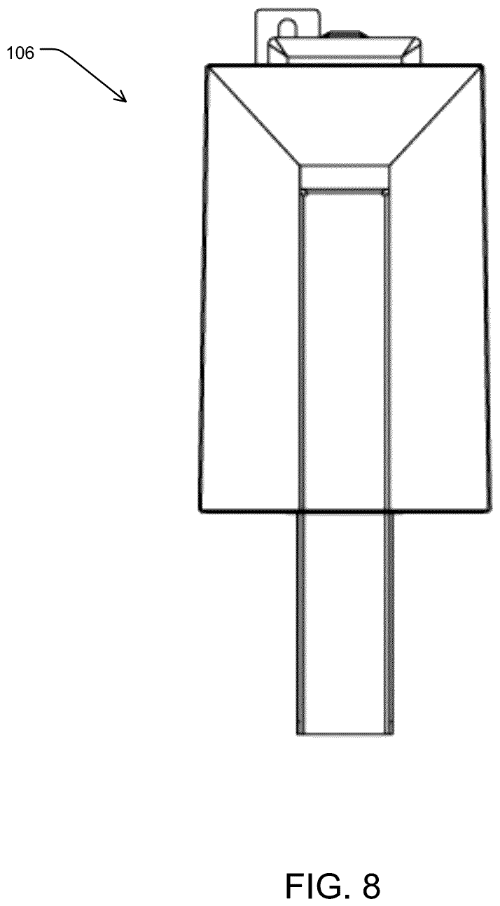

FIG. 5 is a perspective view of the first hopper 106. FIG. 6 is a schematic front view of the first hopper 106. FIG. 7 is a schematic side view of the first hopper 106. FIG. 8 is a schematic top view of the first hopper 106.

As shown in FIGS. 5-8, the first hopper 106 includes a V-shaped container 502 including an exit pan 504 and a gate 506. The exit pan 504 has an elongate shape that directs smokable product from the V-shaped container 502 to the feeder 110. The container 502 has sides 508 that are arranged at an angle α relative to the horizontal 510. In the illustrated embodiment, the angle α is about 70° to about 75° or about 71.0111°. The angle α is configured to consistently feed the smokable product to the exit pan 504. The gate 506 is configured to open and close to feed the smokable product to the exit pan 504. The exit pan 504 is configured to transfer smokable product to the feeder 110.

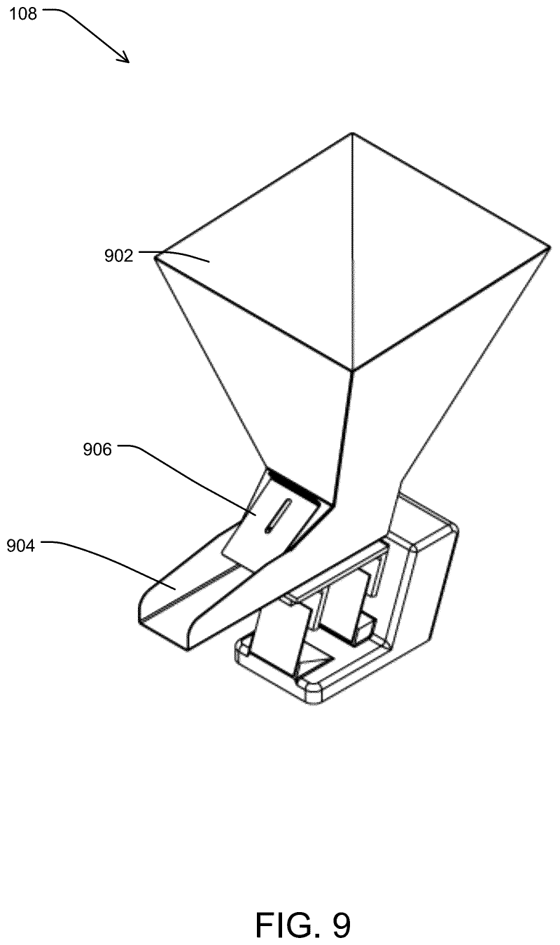

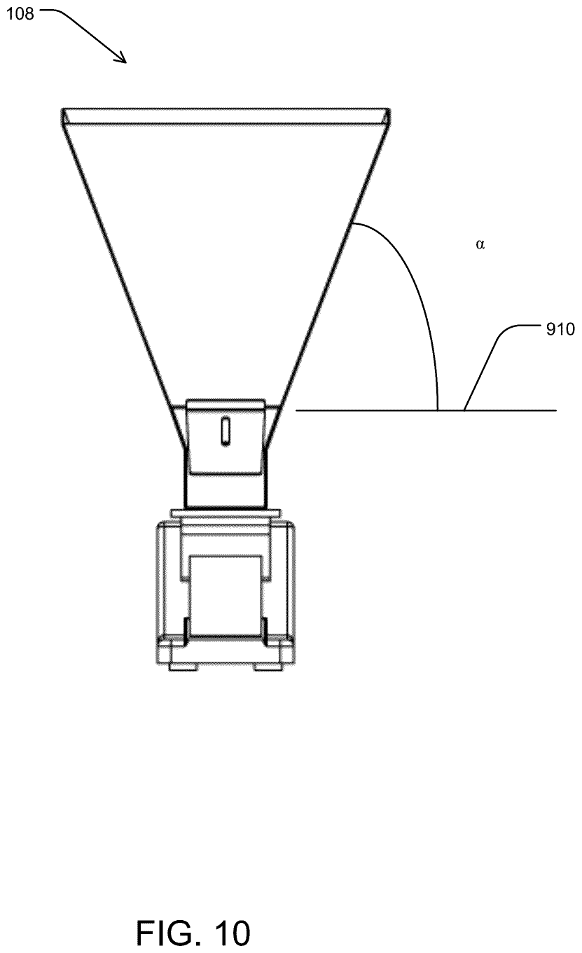

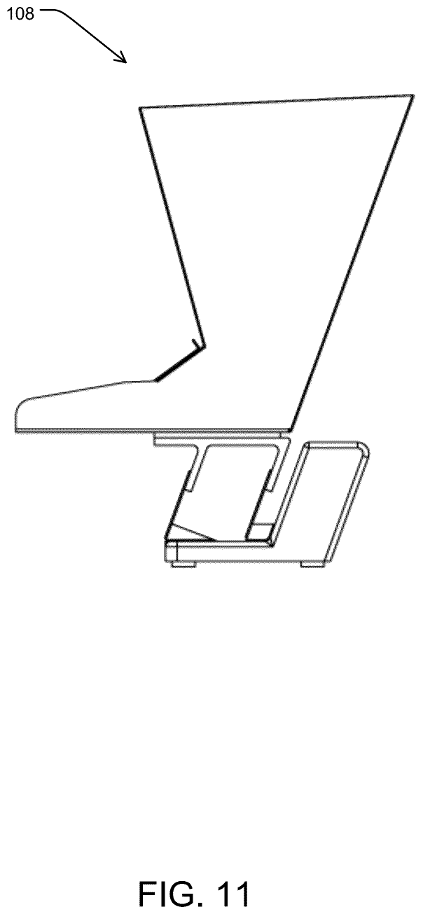

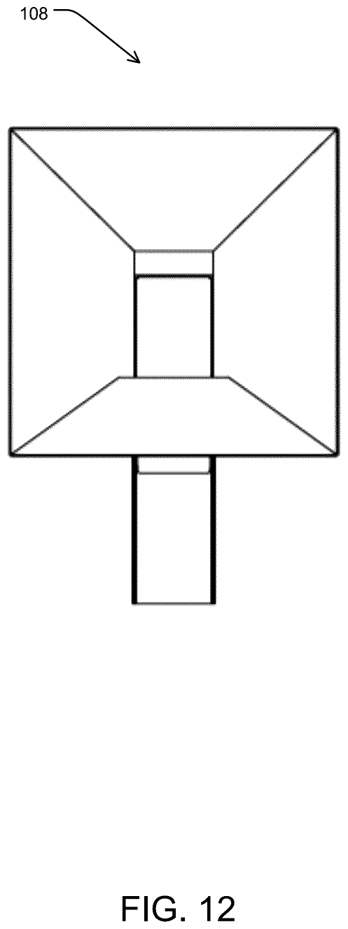

FIG. 9 is a perspective view of the second hopper 108. FIG. 10 is a schematic front view of the second hopper 108. FIG. 11 is a schematic side view of the second hopper 108. FIG. 12 is a schematic top view of the second hopper 108.

As shown in FIGS. 9-12, the second hopper 108 includes a V-shaped container 902 including an exit pan 904 and a gate 906. The exit pan 904 has an elongate shape that directs smokable product from the V-shaped container 902 to the bowl feeder 112. The container 902 has sides 908 that are arranged at an angle α relative to the horizontal 910. In the illustrated embodiment, the angle α is about 70° to about 75° or about 71.0111°. The angle α is configured to consistently feed the smokable product to the exit pan 904. The gate 906 is configured to open and close to feed the smokable product to the exit pan 904. The exit pan 904 is configured to transfer smokable product to the bowl feeder 112.

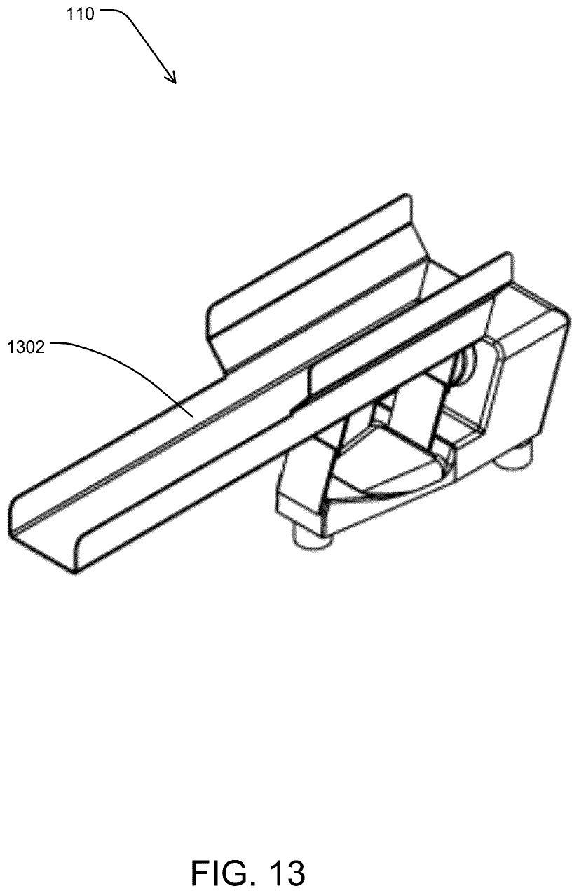

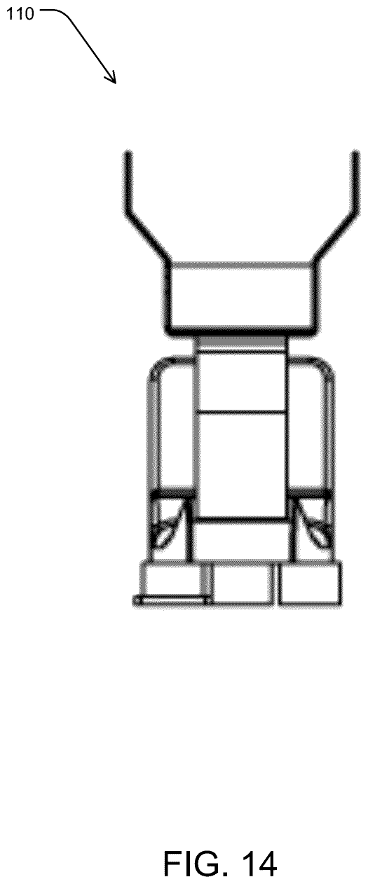

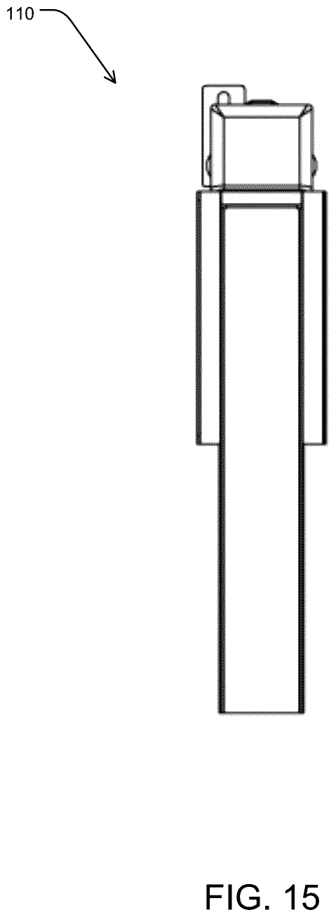

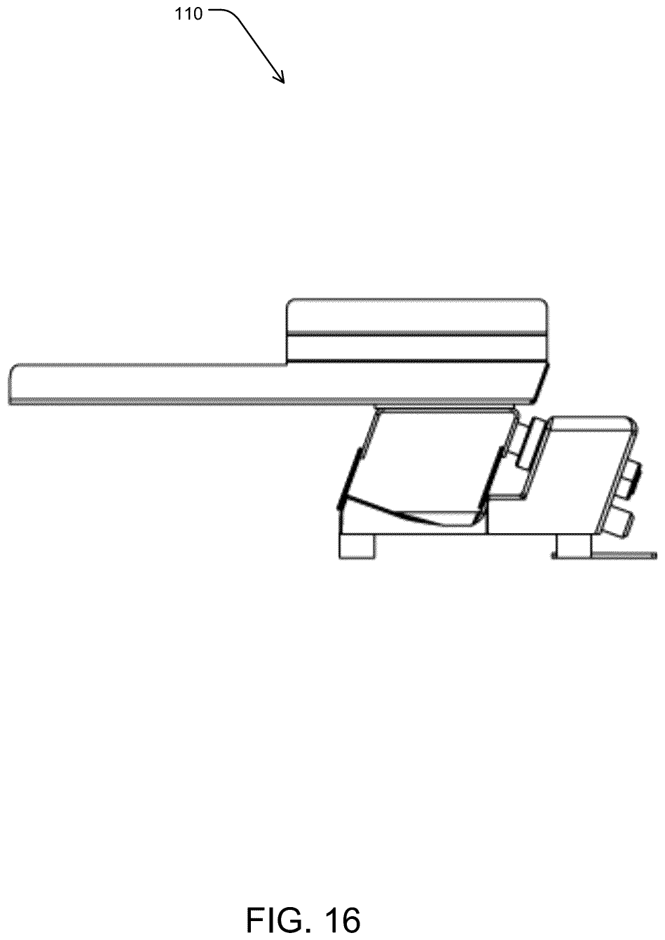

FIG. 13 is a perspective view of the feeder 110. FIG. 14 is a schematic front view of the feeder 110. FIG. 15 is a schematic side view of the feeder 110. FIG. 16 is a schematic top view of the feeder 110.

The feeder 110 is configured to transfer smokable product from the first hopper 106 to the weigh bucket 116 with minimal noise. The optical sensor 128 activates the feeder 110 when the smokable product is low in the feeder 110. The feeder 110 includes a sloped channel 1302 that is positioned proximate to the exit pan 504 to receive smokable product from the exit pan 504. Specifically, opening of the gate 506 channels smokable product from the V-shaped container 502 into the exit pan 504 and onto the feeder 110. Vibration of the vibratory feeder 110 vibrates the sloped channel 1302 to move the smokable product through the sloped channel 1302 and into the weigh bucket 116. A main control console includes a plurality of controls that variably and adjustably control vibration of the vibratory feeder 110.

Specifically, the main control console includes controllers that include variable amplitude and frequency control that is adjustable. Because the consistency of the smokable product varies greatly, the amplitude and frequency of the vibrations of the vibratory feeder 110 may be varied to ensure the consistency of the smokable product fed to the measuring station 124 remains constant. That is, the vibratory feeder 110 may be mechanically and electronically adjusted for product consistency. In the illustrated embodiment, the vibratory feeder 110 is powered by digitally adjustable RC 24vdc variable amplitude and frequency control devices.

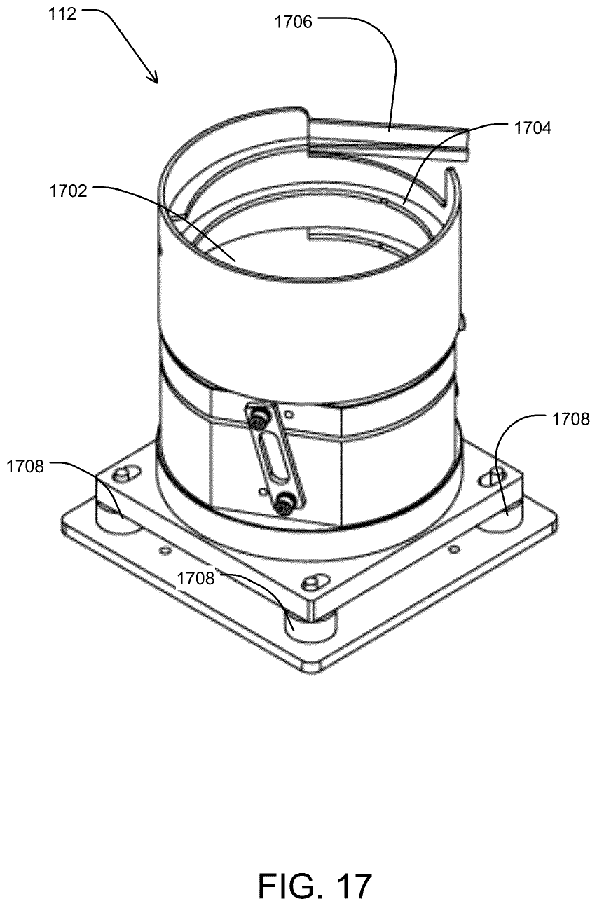

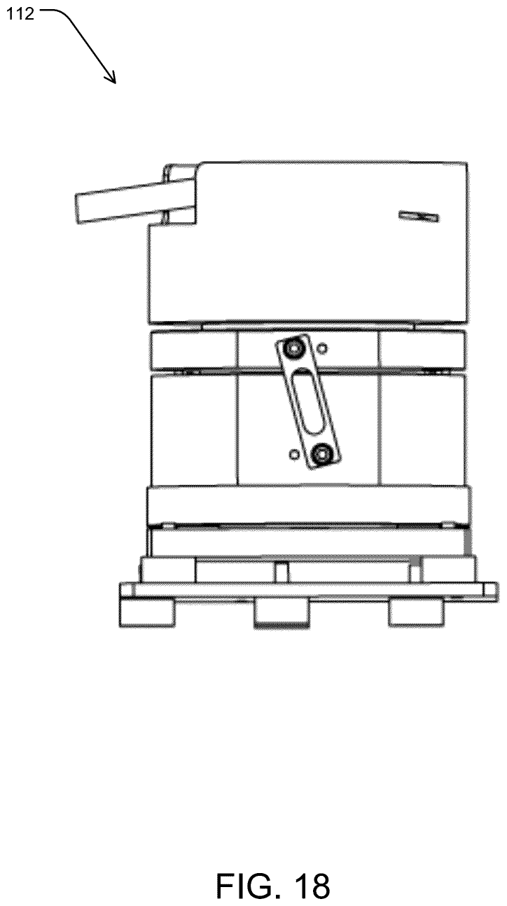

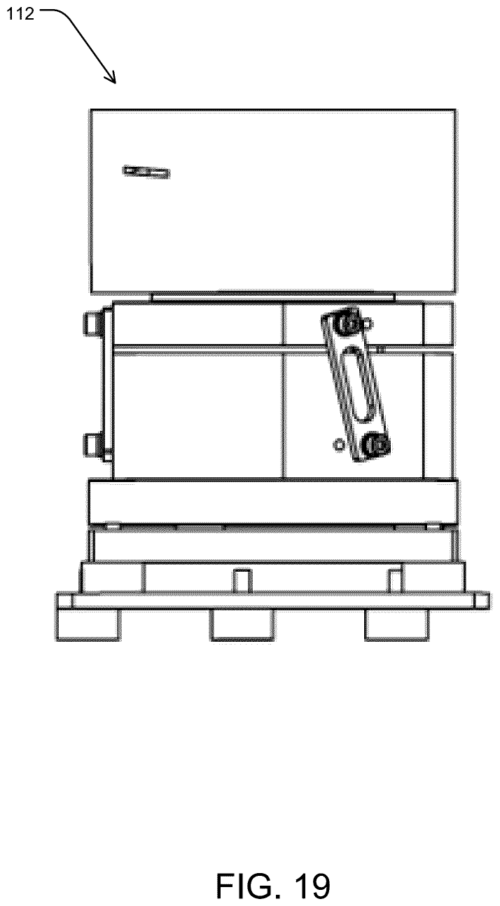

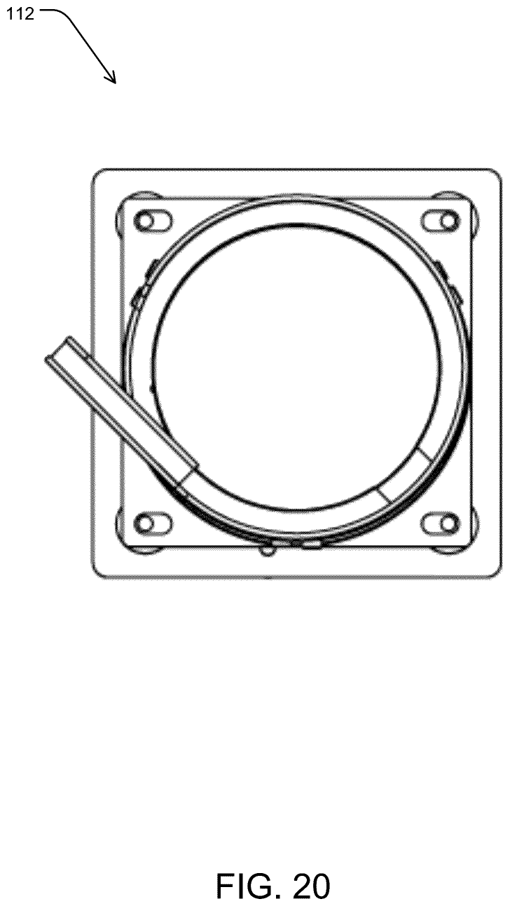

FIG. 17 is a perspective view of the bowl feeder 112. FIG. 18 is a schematic side view of the bowl feeder 112. FIG. 19 is a schematic front view of the bowl feeder 112. FIG. 20 is a schematic top view of the bowl feeder 112.

The bowl feeder 112 is customized to meter the smokable product into the weigh bucket 116 in a controlled and predictable way. As shown in FIGS. 17-20, the bowl feeder 112 includes a bowl 1702, a sweep 1704, and a channel 1706. The bowl 1702 is configured to contain and receive the smokable product from the second hopper 108. The sweep 1704 is positioned within the bowl 1702 and is adjustable to control the flow of smokable product to the channel 1706. In the illustrated embodiment, the sweep 1704 includes a cork-screw ramp that is rotatably positioned within the bowl 1702 to move smokable product from the bowl 1702 to the channel 1706. The sweep 1704 is configured to rotate within the bowl 1702 such that smokable product is raised to the channel 1706. The speed and duration of rotation of the sweep 1704 may be adjusted to control the amount and consistency of smokable product fed to the channel 1706 and the weigh bucket 116. The channel 1706 is attached to and extends from the bowl 1702 such that the channel 1706 extends over the weigh bucket 116. As the smokable product is fed to the channel 1706 by the sweep 1704, the smokable product on the channel 1706 is pushed off the channel 1706 onto the weigh bucket 116. The channel 1706 is sized and shaped to smoothly deliver smokable product to the weigh bucket 116 in a controlled and consistent manner. The bowl feeder 112 includes supports 1708 that double isolate the bowl feeder 112 from the remainder of the measuring station 124 to prevent vibration from affecting the rest of the system. As discussed herein, the main control console includes a plurality of controls that variably and adjustably control the bowl feeder 112.

Specifically, the main control console includes controllers that include variable amplitude and frequency control that is adjustable. Because the consistency of the smokable product varies greatly, the controllers that control the bowl feeder 112 may be varied to ensure the consistency of the smokable product fed to the measuring station 124 remains constant. The variable amplitude and frequency controllers that control the bowl feeder 112 is used to meter the smokable product in a controlled and predictable manner. The bowl feeder 112 can be both mechanically and electronically adjusted for product consistency. In the illustrated embodiment, the bowl feeder 112 are powered by custom digitally adjustable 24vdc variable amplitude and frequency controllers. As such, the bowl feeder 112 rapidly flows the smokable product to the weigh bucket 116 mounted on the load cell 118, to achieve fast cycle time, then slow down to meter the smokable product more precisely as the net weight nears the target. Accordingly, the bowl feeder 112 is designed to precisely meter the smokable product to the weigh bucket 116.

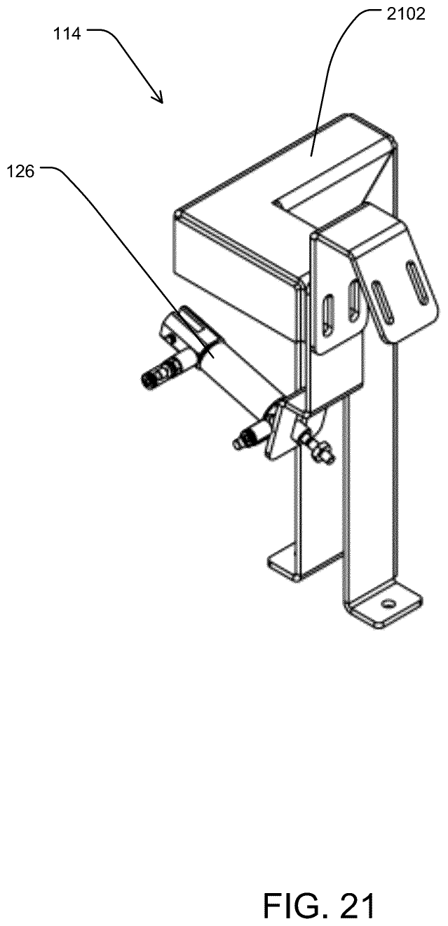

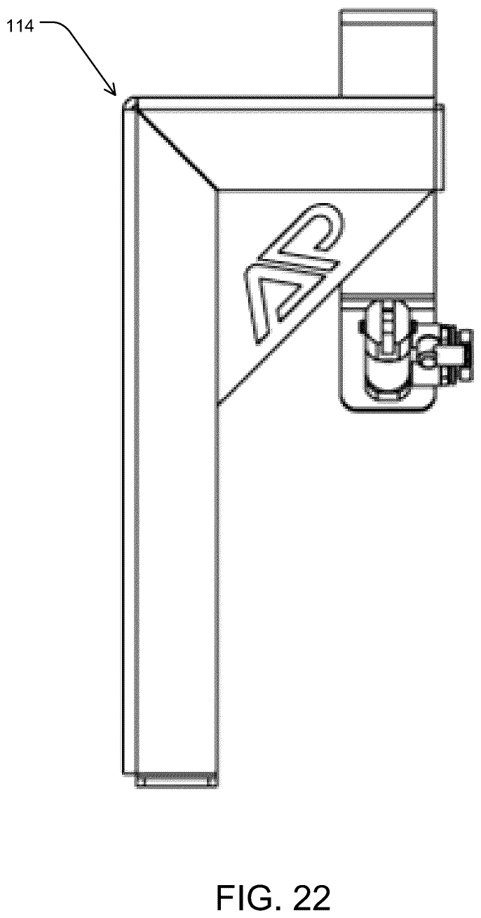

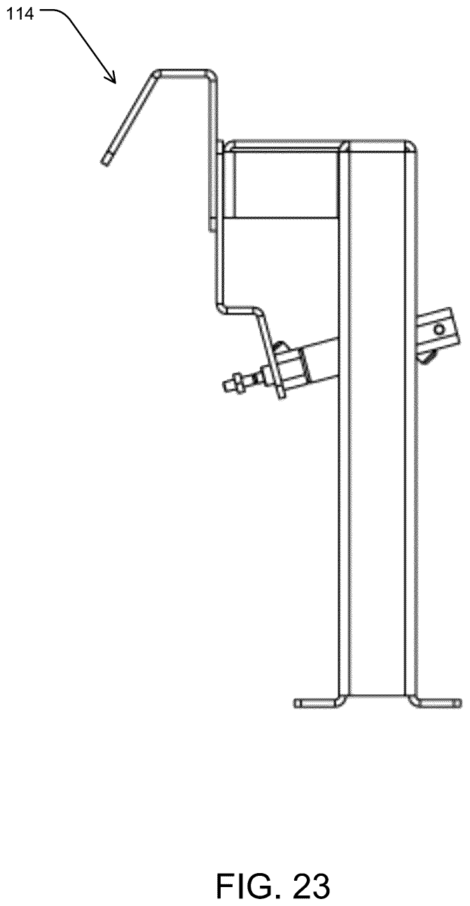

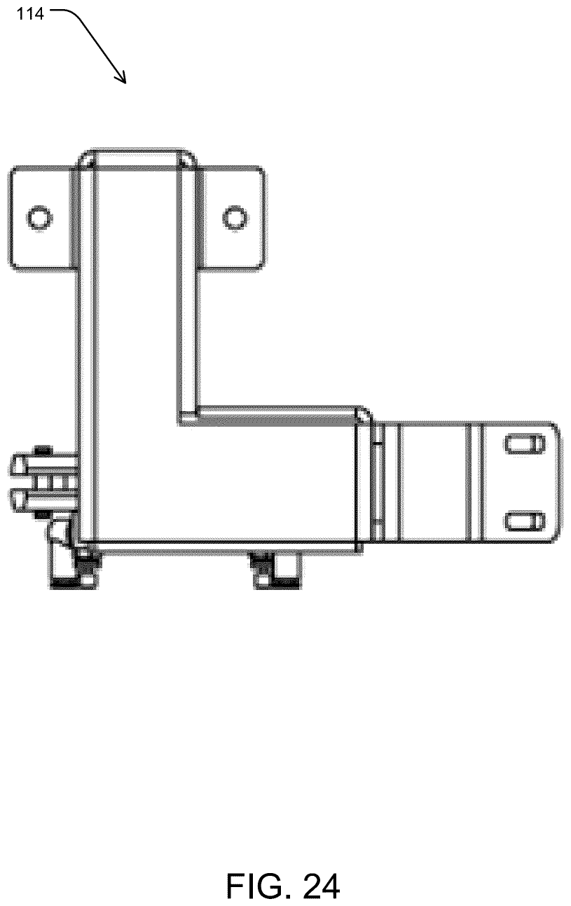

FIG. 21 is a perspective view of the cylinder mount 114. FIG. 22 is a schematic side view of the cylinder mount 114. FIG. 23 is a schematic front view of the cylinder mount 114. FIG. 24 is a schematic top view of the cylinder mount 114.

As shown in FIGS. 21-24, the cylinder mount 114 includes a stand 2102 and the cylinder 126. The weigh bucket 116 is actuated by the cylinder 126 attached to the stand 2102 and configured to open the weigh bucket 116 without affecting the measured weight. The cylinder 126 is configured to open the weigh bucket 116 after the load cell 118 has weighed the smokable product in the weigh bucket such that the smokable product falls into the funnel 122 and the container.

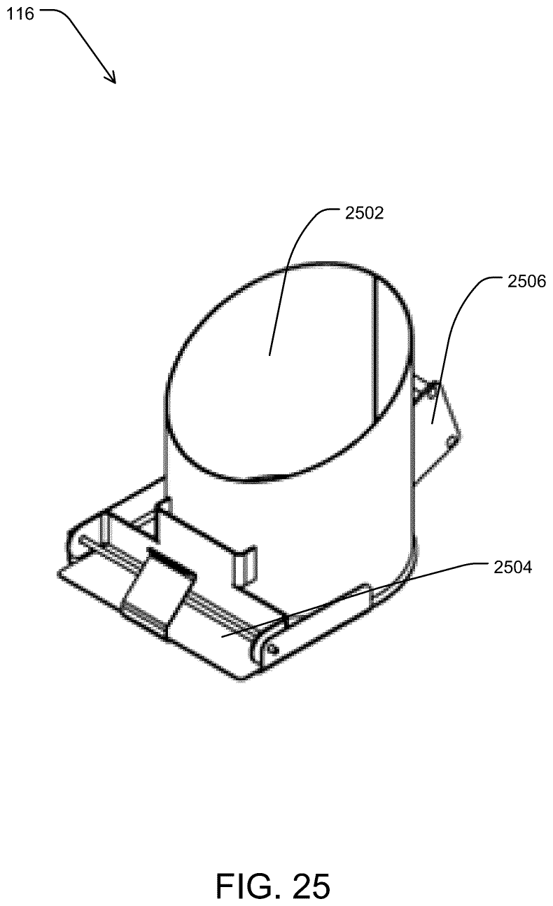

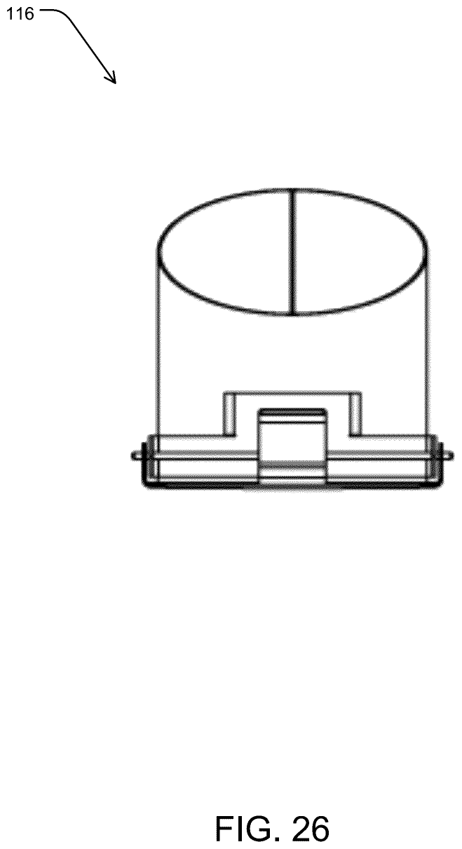

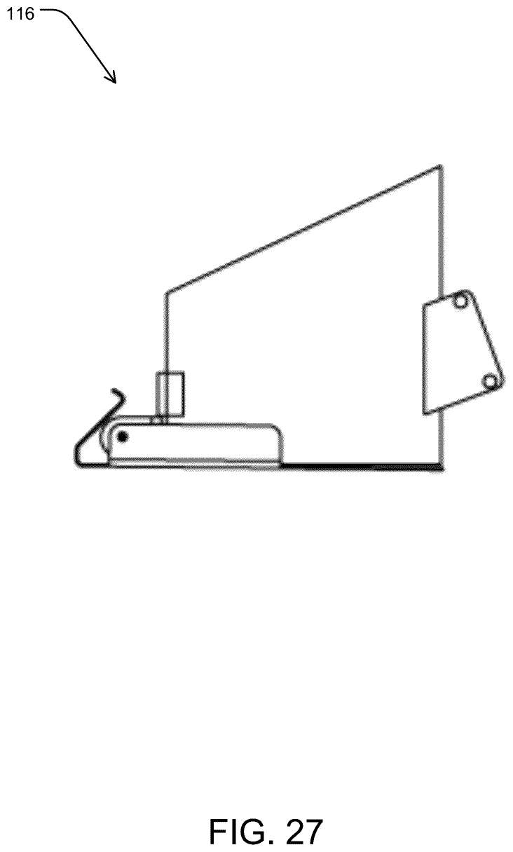

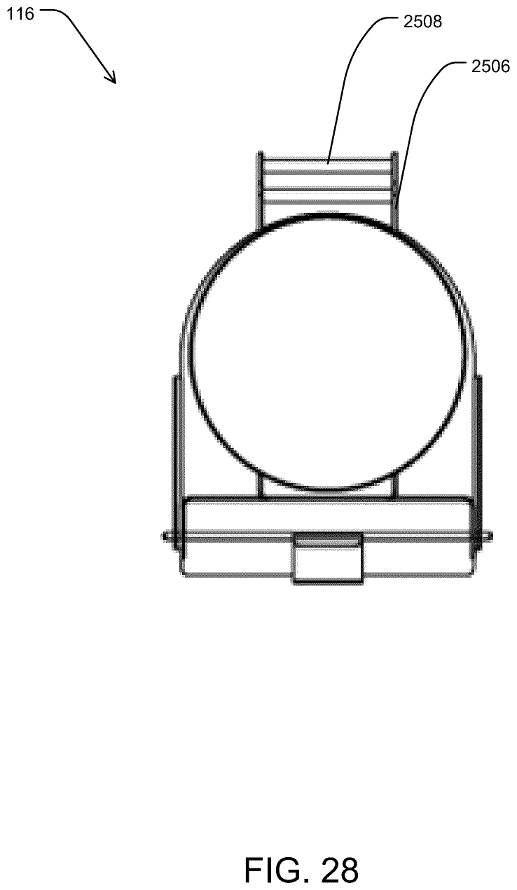

FIG. 25 is a perspective view of the weigh bucket 116. FIG. 26 is a schematic side view of the weigh bucket 116. FIG. 27 is a schematic front view of the weigh bucket 116. FIG. 28 is a schematic top view of the weigh bucket 116.

As shown in FIGS. 25-28, the weigh bucket 116 includes a receiving cylinder 2502, a door 2504, and a load cell mount 2506. The weigh bucket 116 is attached to the load cell 118. The load cell mount 2506 includes bars 2508 that enable quick connect and disconnect of the weigh bucket 116 to and from the load cell 118. The receiving cylinder 2502 receives the product from the feeder 110 and the bowl feeder 112 and the door 2504 and the receiving cylinder 2502 retain the product in the receiving cylinder 2502 while the load cell 118 accurately weighs the product in the weigh bucket 116. Specifically, the load cell 118 weighs the weigh bucket 116 and the product inside the weigh bucket 116 and subtracts the weight of the weigh bucket 116 from the combined weight of the weigh bucket 116 and the product. The load cell 118 has one milligram resolution and is capable of achieving 1/100th of a gram accuracy. The cylinder 126 is attached to the door 2504 which is configured to slide underneath the receiving cylinder 2502. The cylinder 126 slides door 2504 such that a bottom of the receiving cylinder 2502 is open and the product drops from the receiving cylinder 2502 to the weigh bucket 116. The weigh bucket 116 has a custom designed load cell mount 2506 that can be quickly connected to the load cell 118 without the use of tools. The weigh bucket 116 is also designed to be lightweight and rigid.

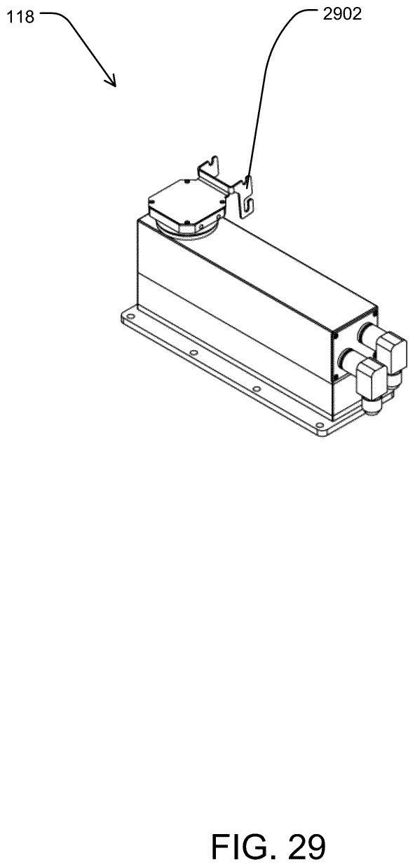

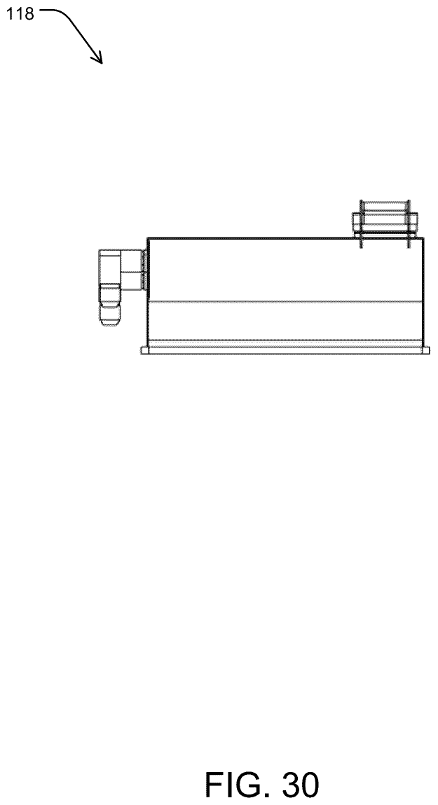

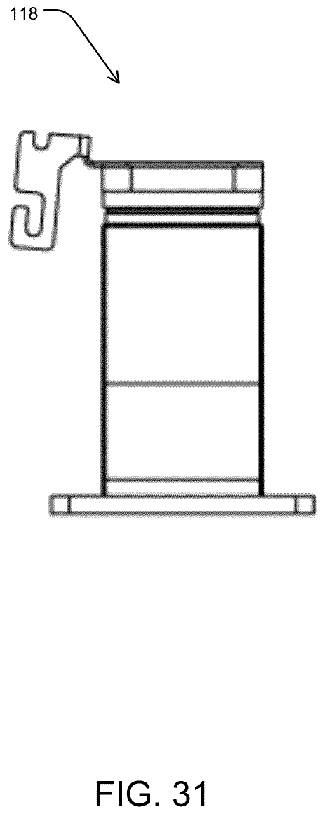

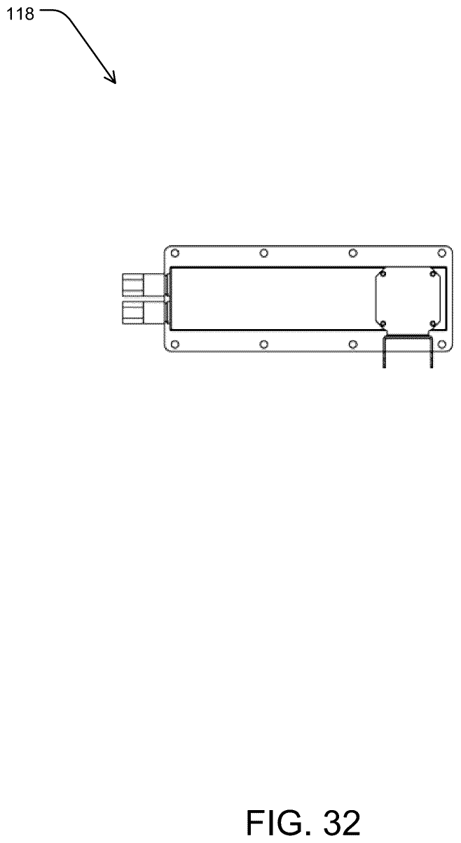

FIG. 29 is a perspective view of the load cell 118. FIG. 30 is a schematic side view of the load cell 118. FIG. 31 is a schematic front view of the load cell 118. FIG. 32 is a schematic top view of the load cell 118.

As shown in FIGS. 29-32, the load cell 118 includes a mount 2902 and weight sensors that have a capacity from 1 gram to 100 kilograms. Preferably, the load cell 118 has a capacity of 1 kilogram. Additionally, the load cell 118 provides a resolution of 0.01 g, +/−0.02 g accuracy with the custom software. An analog output is read in increments of 1/10,000 of a millivolt (mv); or one millionth of a volt from the load cell 118. The load cell 118 is fitted with a custom cover to reduce interference and protect each load cell from damage. The mount 2902 mounts the weigh bucket 116 to the load cell 118.

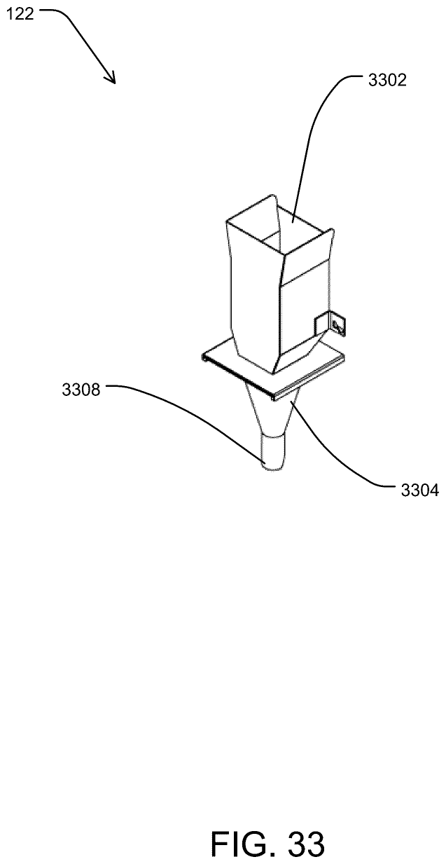

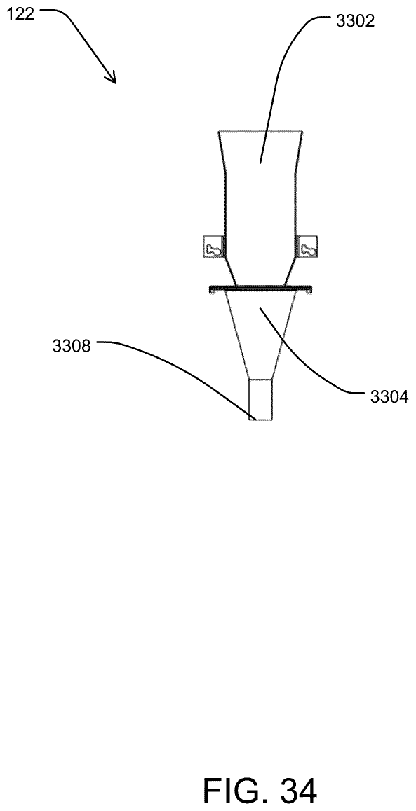

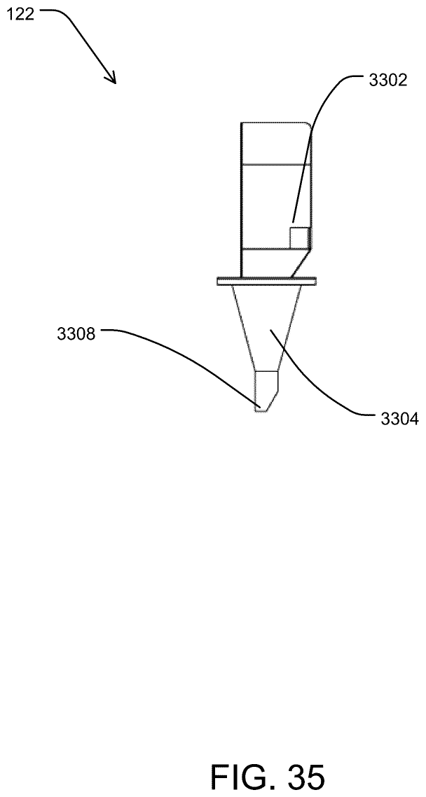

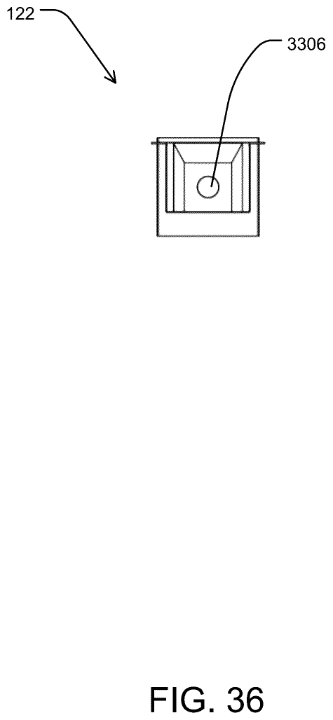

FIG. 33 is a perspective view of the funnel 122. FIG. 34 is a schematic side view of the funnel 122. FIG. 35 is a schematic front view of the funnel 122. FIG. 36 is a schematic top view of the funnel 122.

As shown in FIGS. 33-36, the funnel 122 includes a vertical channel 3302 and a cone 3304. The vertical channel 3302 is attached to the system 100 and the cone 3304 is attached to the vertical channel 3302. The vertical channel 3302 receives the smokable product from the weigh bucket 116 and feeds the smokable product to the cone 3304. The cone 3304 is cone shaped with a hole 3306 at an end 3308 of the cone 3304 such that the smokable product is funneled into the container.

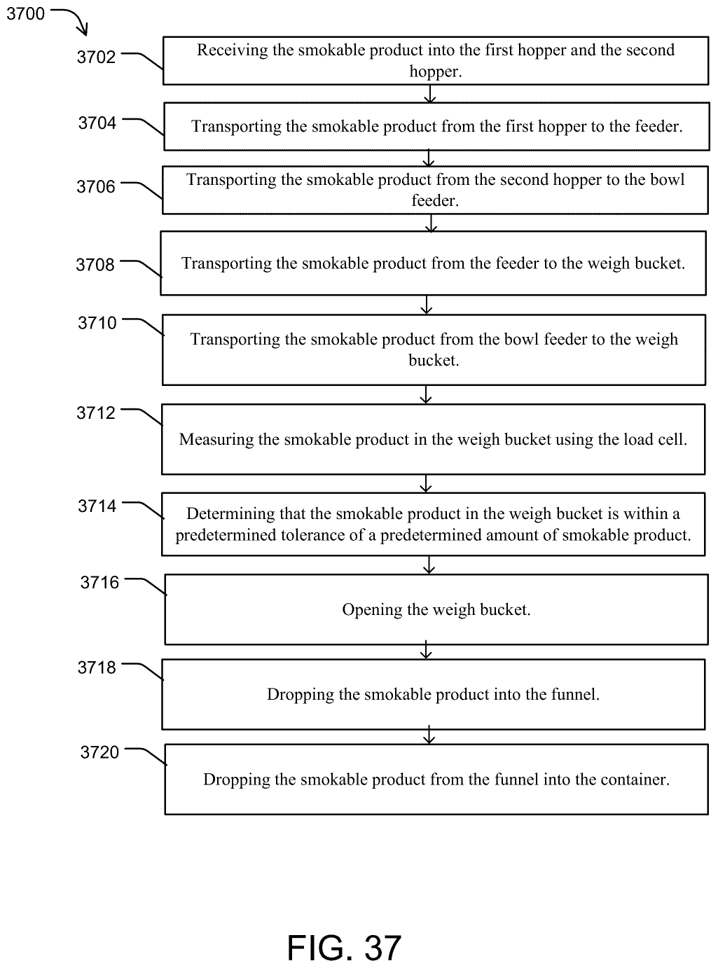

FIG. 37 is a flowchart of operations 3700 for a method of filling a container with a smokable product using a filling system. The filling system includes a first hopper, a second hopper, a feeder, a bowl feeder, a weigh bucket, a load cell, and a funnel. The method includes receiving 3702 the smokable product into the first hopper and the second hopper. The method also includes transporting 3704 the smokable product from the first hopper to the feeder. The method further includes transporting 3706 the smokable product from the second hopper to the bowl feeder. The method also includes transporting 3708 the smokable product from the feeder to the weigh bucket. The method further includes transporting 3710 the smokable product from the bowl feeder to the weigh bucket. The method also includes measuring 3712 the smokable product in the weigh bucket using the load cell. The method further includes determining 3714 that the smokable product in the weigh bucket is within a predetermined tolerance of a predetermined amount of smokable product. The method also includes opening 3716 the weigh bucket. The method further includes dropping 3718 the smokable product into the funnel. The method also includes dropping 3720 the smokable product from the funnel into the container.

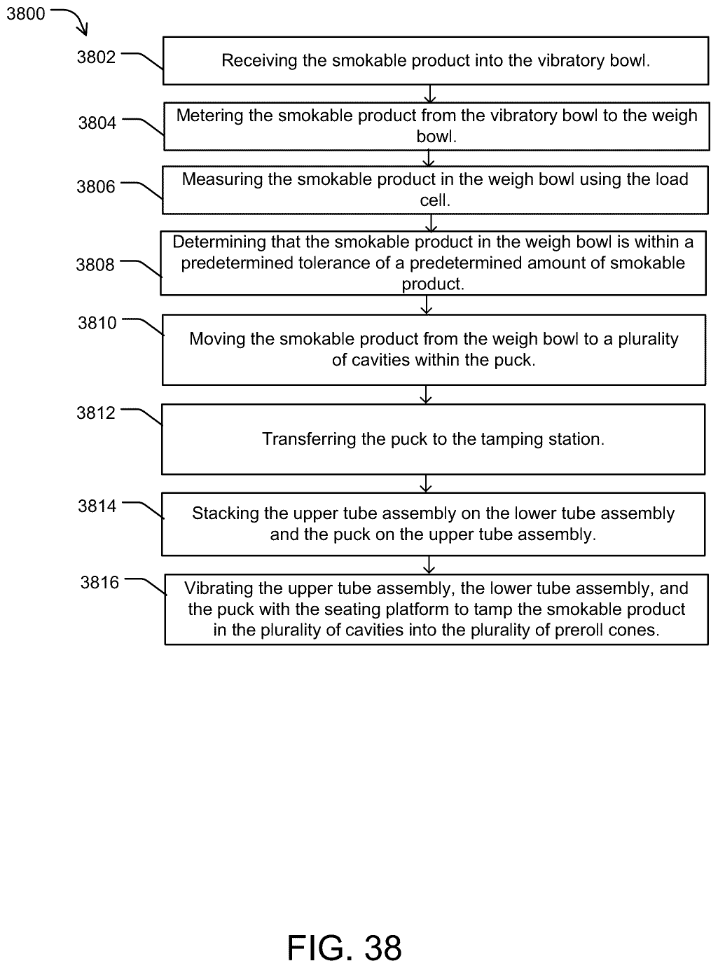

FIG. 38 is a flowchart of operations 3800 for a method of filling preroll cones with a smokable product using a filling system. The filling system includes a vibratory bowl, a weigh bowl, a load cell, a puck, a tamping station, an upper tube assembly, a lower tube assembly, a seating platform, and preroll cones. The method includes receiving 3802 the smokable product into the vibratory bowl. The method also includes metering 3804 the smokeable product from the vibratory bowl to the weigh bowl. The method includes measuring 3806 the smokeable product in the weigh bowl using the load cell. The method includes determining 3808 that the smokeable product in the weigh bowl is within a predetermined tolerance of a predetermined amount of smokeable product. The method includes moving 3810 the smokeable product from the weight bowl to a plurality of cavities within the puck. The method also includes transferring 3812 the puck to the tamping station. The method includes stacking 3814 the upper tube assembly on the lower tube assembly and the puck on the upper tube assembly. The method additionally includes vibrating 3816 the upper tube assembly, the lower tube assembly, and the puck with the seating platform to tamp the smokable product in the plurality of cavities into a plurality of preroll cones.

What has been described is a new and improved system for an accurate net weight based filling system for filling containers in a compliant, consistent, repeatable, and scalable manner.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A filling system comprising:
a first hopper for receiving a smokable product;
a second hopper for receiving the smokable product;
a feeder for receiving the smokable product from the first hopper;
a bowl feeder for receiving the smokable product from the second hopper;
a weigh bucket for receiving the smokable product from the feeder and the bowl feeder;
a load cell attached to the weigh bucket for measuring the smokable product in the weigh bucket; and
a funnel for receiving the smokable product from the weigh bucket and feeding the smokable product to a container, wherein the container is configured to receive a predetermined amount of smokable product within a predetermined tolerance of the predetermined amount.

2. The filling system of claim 1, wherein the first hopper and the second hopper each include a V-shaped container including sides defining an angle relative to a horizon.

3. The filling system of claim 2, wherein the angle is about 70° to about 75°.

4. The filling system of claim 2, wherein the first hopper further comprises a gate.

5. The filling system of claim 1, wherein the weigh bucket comprises a receiving cylinder and a door, wherein the receiving cylinder is configured to receive the smokable product and the door is configured to open to drop the smokable product into the funnel.

6. The filling system of claim 5, further comprising an air cylinder configured to open the door.

7. The filling system of claim 1, wherein the funnel comprises a vertical channel and a cone.

8. The filling system of claim 1, wherein the bowl feeder comprises a bowl and a sweep positioned within the bowl.

9. The filling system of claim 8, wherein the sweep rotates within the bowl, and wherein the bowl feeder further comprises a channel configured to receive the smokable product from the sweep and configured to feed the smokable product to the weigh bucket.

10. The filling system of claim 9, wherein the channel is configured to drop individual nuggets of smokable product into the weigh bucket.

11. A filling system comprising:
a first hopper for receiving a smokable product;
a second hopper for receiving the smokable product;
a feeder for receiving the smokable product from the first hopper;
a bowl feeder for receiving the smokable product from the second hopper and comprising a bowl, a sweep, and a channel, wherein the sweep is positioned within the bowl and configured to rotate within the bowl;
a weigh bucket for receiving the smokable product from the feeder and the bowl feeder, the weigh bucket comprising a receiving cylinder and a door, wherein the receiving cylinder is configured to receive the smokable product from the feeder and from the channel;
a load cell attached to the weigh bucket for measuring the smokable product in the weigh bucket; and
a funnel for receiving the smokable product from the weigh bucket and feeding the smokable product to a container, wherein the door is configured to open to drop the smokable product into the funnel, and wherein the container is configured to receive a predetermined amount of smokable product within a predetermined tolerance of the predetermined amount.

12. The filling system of claim 11, further comprising an air cylinder configured to open the door.

13. The filling system of claim 11, wherein the funnel comprises a vertical channel and a cone.

14. The filling system of claim 11, wherein the first hopper and the second hopper each include a V-shaped container including sides defining an angle relative to a horizon.

15. A method of filling a container with a smokable product using a filling system, the filling system comprises a first hopper, a second hopper, a feeder, a bowl feeder, a weigh bucket, a load cell, and a funnel, the method comprises:
receiving the smokable product into the first hopper and the second hopper;
transporting the smokable product from the first hopper to the feeder;
transporting the smokable product from the second hopper to the bowl feeder;
transporting the smokable product from the feeder to the weigh bucket;
transporting the smokable product from the bowl feeder to the weigh bucket;
measuring the smokable product in the weigh bucket using the load cell;
determining that the smokable product in the weigh bucket is within a predetermined tolerance of a predetermined amount of smokable product;
opening the weigh bucket;
dropping the smokable product into the funnel; and
dropping the smokable product from the funnel into the container.

16. The method of claim 15, wherein the bowl feeder comprises a bowl and a sweep, and wherein the method further comprises rotating the sweep in the bowl.

17. The method of claim 16, wherein the bowl feeder further comprises a channel, and wherein the method further comprises transporting the smokable product into the channel using the sweep and transporting the smokable product into the weigh bucket using the channel.

18. The method of claim 15, wherein the weigh bucket comprises a receiving cylinder and a door, and wherein transporting the smokable product from the feeder to the weigh bucket comprises transporting the smokable product from the feeder to the receiving cylinder.

19. The method of claim 18, wherein dropping the smokable product into the funnel comprises opening the door and dropping the smokable product into the funnel.

20. The method of claim 15, wherein determining that the smokable product in the weigh bucket is within a predetermined tolerance of a predetermined amount of smokable product comprises determining that the smokable product in the weigh bucket is within a predetermined tolerance of a predetermined amount of smokable product using the load cell.
